(19) United States
(12) Patent Application Publication
(10) Pub. No.: US 2016/0269738 A1
(43) Pub. Date: Sep. 15, 2016

(54) METHOD FOR ENCODING AND DECODING IMAGES, DEVICE FOR ENCODING AND DECODING IMAGES, AND CORRESPONDING COMPUTER PROGRAMMES

(71) Applicant: ORANGE, Paris (FR)

(72) Inventors: Felix Henry, Saint Gregoire (FR); Bihong Huang, Cesson Sevigne (FR)

(21) Appl. No.: 15/029,738

(22) PCT Filed: Oct. 13, 2014
(86) PCT No.: PCT/FR2014/052605

§ 371 Date: Apr. 15, 2016

(30) Foreign Application Priority Data
Oct. 15, 2013 (FR) 1360033

(51) Int. Cl. H04N 19/51; H04N 19/70; H04N 19/86; H04N 19/176; H04N 19/625; H04N 19/119; H04N 19/174; H04N 19/55; H04N 19/567

(52) U.S. Cl. CPC H04N 19/51; H04N 19/55; H04N 19/70; H04N 19/86; H04N 19/567; H04N 19/625; H04N 19/119; H04N 19/174; H04N 19/176

(57) ABSTRACT

A method and apparatus are provided for encoding at least one image divided into blocks. The method includes, for a current block to be encoded, acts of: determining a set of candidate predictive blocks; for at least one candidate predictive block from the set: obtaining a residual bloc representative of the difference between the candidate predictive block and the current block, identifying, in the set of candidate predictive blocks, a candidate predictive block, the identification being a function of the obtained current residual block, and selecting the at least one candidate predictive block if it is equal to the identified predictive block; determining, from the candidate predictive blocks likely to have been selected at the end of the selection step, a candidate predictive block, by using a predefined criterion; and encoding a residual block representative of the difference between the determined candidate predictive block and the current block.

### CROSS-REFERENCE TO RELATED APPLICATIONS

This Application is a Section 371 National Stage Application of International Application No. PCT/FR2014/052605, filed Oct. 13, 2014, the content of which is incorporated herein by reference in its entirety, and published as WO 2015/055937 on Apr. 23, 2015, not in English.

### FIELD OF THE INVENTION

The present invention pertains generally to the field of image processing and more precisely to the coding and to the decoding of digital images and of sequences of digital images.

The coding/decoding of digital images applies in particular to images arising from at least one video sequence comprising:
images arising from one and the same camera and following one another temporally (coding/decoding of 2D type),
images arising from various cameras oriented according to different views (coding/decoding of 3D type),
corresponding texture and depth components (coding/decoding of 3D type),
etc.

The present invention applies in a similar manner to the coding/decoding of images of 2D or 3D type.

The invention can in particular, but not exclusively, apply to the video coding implemented in current AVC and HEVC video coders and their extensions (MVC, 3D-AVC, MV-HEVC, 3D-HEVC, etc.), and to the corresponding decoding.

### PRIOR ART

Digital images and sequences of digital images occupy a great deal of space in terms of memory, thereby making it necessary, when these images are transmitted, to compress them so as to avoid problems of crowding on the communication network used for this transmission, the bitrate usable on the latter generally being limited. This compression is also desirable with a view to the storage of these data.

Numerous video data compression techniques are already known. Among the latter, numerous video coding techniques, in particular the HEVC technique, use techniques of spatial or temporal prediction of groups of blocks of pixels of a current image with respect to other groups of blocks of pixels belonging to the same image or to a preceding or following image.

More precisely, according to the HEVC technique, I images are coded by spatial prediction (intra prediction), and P and B images are coded by temporal prediction (inter prediction) with respect to other I, P or B images coded/decoded with the aid of a motion compensation.

For this purpose, the images are cut up a first time into blocks of pixels called CTUs (the abbreviation standing for “Coded Treeblocks Unit”) which are similar to the macroblocks of the H.264 standard. These blocks can thereafter be subdivided into smaller blocks, each of these smaller blocks or each CTU block being coded by intra or inter image prediction.

According to the HEVC technique, when a CTU block is subdivided into smaller blocks, a data signal, corresponding to each block, is transmitted to the decoder. Such a signal comprises:
residual data which are the coefficients of the quantized residual blocks,
coding parameters which are representative of the mode of coding used, in particular:
   the mode of prediction (intra prediction, inter prediction, default prediction carrying out a prediction for which no item of information is transmitted to the decoder (known as “skip”));
   items of information specifying the type of prediction (orientation, reference image, etc.);
   the type of subdivision;
   the type of transform, for example 4×4 DCT, 8×8 DCT, etc.
   the items of motion information if necessary;
   etc.

Decoding is done image by image, and for each image, CTU block by CTU block. For each smaller block of a CTU block, the corresponding elements of the stream are read. The inverse quantization and the inverse transformation of the coefficients of the smaller blocks are performed. Next, the prediction of each CTU block is calculated and each CTU block is reconstructed by adding the prediction to the decoded prediction residual.

Intra or inter coding by competition, such as implemented in the HEVC standard, thus relies on setting various coding parameters, such as those aforementioned, into competition with the aim of selecting the best mode of coding, that is to say that which will optimize the coding of the block considered according to a predetermined performance criterion, for example the bitrate/distortion cost well known to the person skilled in the art.

The coding parameters relating to the mode of coding selected are contained in the data stream transmitted by the coder to the decoder, in the form of identifiers generally called competition indices. The decoder is thus capable of identifying the mode of coding selected at the coder, and then of applying the prediction in accordance with this mode.

The bandwidth allocated to these competition indices is not negligible, since it reaches about 30%. It is tending moreover to increase because of the ever-growing uptake of new coding parameters such as new dimensions and/or shapes of pixel blocks, of new parameters of Intra prediction, Inter prediction, etc.

### SUMMARY OF THE INVENTION

A subject of the present invention relates to a method for coding at least one image cut up into blocks.

Such a coding method is noteworthy in that it comprises, for a current block to be coded, the steps of:
determination of a set of candidate predictor blocks,
for at least one candidate predictor block of the aforementioned set:
   obtaining of a residual block representative of the difference between the candidate predictor block and the current block,
   identification, in the set of candidate predictor blocks, of a candidate predictor block, such an identification being dependent on the current residual block obtained,
   selection of said at least one candidate predictor block if it is equal to the predictor block identified,
determination, from among the candidate predictor blocks liable to have been selected on completion of the selection step, of a candidate predictor block, with the aid of a predetermined criterion,
coding of the residual block representative of the difference between the candidate predictor block determined and the current block.

Such an arrangement makes it possible, during the coding of an image, to avoid including in the signal to be transmitted to the decoder the indices of the predictor blocks which are used to predict respectively the blocks of the image. This thus results in a non-negligible decrease in the signaling cost, insofar as such an arrangement is reproducible at the decoder.

Furthermore, the identification of candidate predictor blocks with a view to the prediction of the current block is particularly reliable. It results from the fact that for a current residual block considered, the characteristics of the candidate predictor blocks are very different from one another, thereby facilitating the final selection of the candidate predictor block that is most suitable during the step of determination according to a predetermined criterion.

According to a particular embodiment, the blocks of the image preceding the current block being coded in a determined order, the aforementioned identification is dependent on the previously coded pixels of the image.

Such an arrangement thus makes it possible to take account of items of information of the image which are already available at the time of the coding of the current block, thus increasing the performance of the identification of the candidate predictor blocks.

According to a preferred embodiment of the invention, the previously coded pixels of the image are situated along the current block.

Such an arrangement thus makes it possible to minimize the discontinuities liable to occur along the boundaries of the current block, while corresponding better to the reality of the image.

According to a particular embodiment, the predetermined criterion is the minimization of the image bitrate-distortion cost.

The choice of such a criterion optimizes the prediction performed when coding.
According to a particular embodiment, the current block is a block which has been previously obtained subsequent to a prediction.

The aim of such an arrangement is to further refine the prediction of the current block so as to obtain optimized coding performance.

The various aforementioned embodiments or characteristics of embodiment can be added independently or in combination with one another to the steps of the coding method such as defined hereinabove.

The invention also relates to a device for coding at least one image cut up into blocks, such a device being noteworthy in that it comprises, for a current block to be coded:
a module for determining, a set of candidate predictor blocks,
for at least one candidate predictor block of the set:
   a module for obtaining a residual block representative of the difference between the candidate predictor block and the current block,
   a module for identifying, in the set of candidate predictor blocks, a candidate predictor block, as a function of the current residual block obtained,
   a module for selecting said at least one candidate predictor block if it is equal to the predictor block identified,
a module for determining, from among the candidate predictor blocks liable to have been selected on completion of the selection step, a candidate predictor block, with the aid of a predetermined criterion,
a module for coding the residual block representative of the difference between the candidate predictor block determined and the current block.

Such a coding device is able to implement the aforementioned coding method.

The invention also relates to a method for decoding a data signal representative of at least one image cut up into blocks, such a method comprising the steps of:
determination, in the data signal, of data representative of a current residual block associated with a current block to be decoded,
decoding of the current residual block.

The decoding method according to the invention is noteworthy in that it comprises, for a current block to be reconstructed, the steps of:
determination of a set of candidate predictor blocks,
identification, in the aforementioned set, of a candidate predictor block, such an identification being dependent on said decoded current residual block,
reconstruction of the current block with the aid of the identified predictor block and of the decoded current residual block.

An advantage of such a decoding method resides in the fact that the step of identification of the predictor block able to reconstruct the current block is reproducible when decoding. The data signal received at the decoder does not advantageously contain items of information associated with this identified predictor block, thereby noticeably reducing the cost of signaling of these items of information.

Furthermore, the fact that the identification of the predictor block is dependent on the decoded current residual block allows reliable reconstruction of the current block. The characteristics of the candidate predictor blocks of the set determined being very different from one another, the identification of the predictor block retained for the reconstruction of the current block is thereby facilitated. This results in a decoding of the image of better quality.

According to a particular embodiment, the blocks of the image preceding the current block being decoded in a determined order, the identification of a predictor block is dependent on the previously decoded pixels of the image.

According to another particular embodiment, the previously decoded pixels of the image are situated along the current block.

According to another particular embodiment, the decoding method furthermore comprises a step of determination, in the data signal, of an item of information associated with a prior prediction of the current block, said step of reconstructing the current block being implemented on the basis of such a prior prediction, of the identified predictor block and of the determined current residual block.

Such an arrangement makes it possible to further refine the prediction so as to obtain optimized decoding performance.

The various aforementioned embodiments or characteristics of embodiment can be added independently or in combination with one another to the steps of the decoding method such as defined hereinabove.

In a corresponding manner, the invention also relates to a device for decoding a data signal representative of at least one image cut up into blocks, such a device comprising:
a module for determining, in the data signal, data representative of a current residual block associated with a current block to be decoded,
a module for decoding said current residual block.

Such a decoding device is noteworthy in that it comprises, for a current block to be reconstructed:
a module for determining a set of candidate predictor blocks,
a module for identifying, in said set, a candidate predictor block, said identifying being dependent on said decoded current residual block,
a module for reconstructing the current block with the aid of the identified predictor block and of the decoded current residual block.

Such a decoding device is able to implement the aforementioned decoding method.

The invention further relates to a computer program comprising instructions for implementing one of the coding and decoding methods according to the invention, when it is executed on a computer.

This program can use any programming language, and be in the form of source code, object code, or of code intermediate between source code and object code, such as in a partially compiled form, or in any other desirable form.

The invention also envisages a recording medium readable by a computer on which is recorded a computer program, this program comprising instructions suitable for the implementation of one of the methods according to the invention, such as described hereinabove.

The invention also envisages a recording medium readable by a computer on which is recorded a computer program, this program comprising instructions suitable for the implementation of the coding or decoding method according to the invention, such as described hereinabove.

The recording medium can be any entity or device capable of storing the program. For example, the medium can comprise a storage means, such as a ROM, for example a CD ROM or a microelectronic circuit ROM, or else a magnetic recording means, for example a USB key or a hard disk.

Moreover, the recording medium can be a transmissible medium such as an electrical or optical signal, which can be conveyed via an electrical or optical cable, by radio or by other means. The program according to the invention can be in particular downloaded from a network of Internet type.

Alternatively, the recording medium can be an integrated circuit into which the program is incorporated, the circuit being suitable for executing or for being used in the execution of the aforementioned coding or decoding method.

The decoding method, the coding device, the decoding device, the computer programs and the recording media aforementioned corresponding thereto exhibit at least the same advantages as those conferred by the coding and decoding method according to the present invention.

### BRIEF DESCRIPTION OF THE DRAWINGS

Other characteristics and advantages will become apparent on reading preferred embodiments described with reference to the figures in which:

FIGS. 1A and 1B represent steps of the coding method according to an embodiment of the invention,

FIG. 2 represents an embodiment of a coding device according to the invention able to implement the coding method of FIGS. 1A and 1B,

FIG. 3 represents an exemplary partitioning of the current image into several blocks of pixels,

FIG. 4 represents an embodiment according to the invention of the step of identifying a candidate predictor block as a function of the current decoded residual block obtained,

FIG. 5 represents steps of the coding method according to another embodiment of the invention,

FIG. 6 represents an embodiment of a coding device according to the invention able to implement the coding method of FIG. 5,

FIG. 7 represents steps of the decoding method according to an embodiment of the invention,

FIG. 8 represents an embodiment of a decoding device according to the invention able to implement the decoding method of FIG. 7,

FIG. 9 represents steps of the decoding method according to another embodiment of the invention,

FIG. 10 represents an embodiment of a decoding device according to the invention able to implement the decoding method of FIG. 9.

### DETAILED DESCRIPTION OF ILLUSTRATIVE EMBODIMENTS

### Detailed Description of an Embodiment of the Coding Part

An embodiment of the invention will now be described, in which the coding method according to the invention is used to code an image or a sequence of images according to a binary stream close to that obtained by a coding complying for example with the HEVC standard.

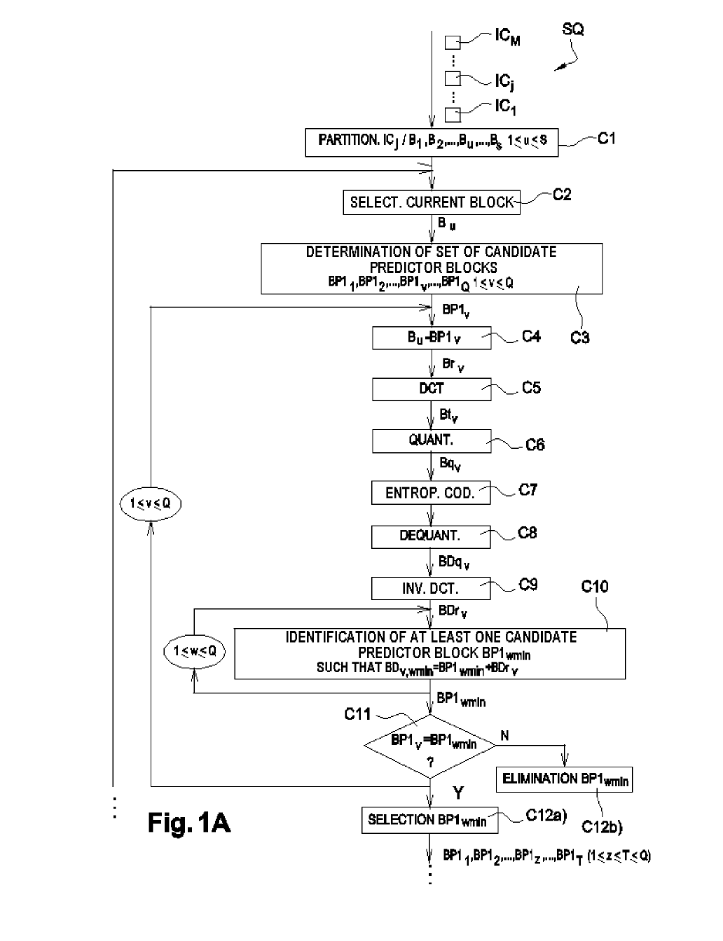

In this embodiment, the coding method according to the invention is for example implemented in a software or hardware manner by modifications of a coder initially complying with the HEVC standard. The coding method according to the invention is represented in the form of an algorithm comprising steps C1 to C22 such as represented in FIGS. 1A and 1B.

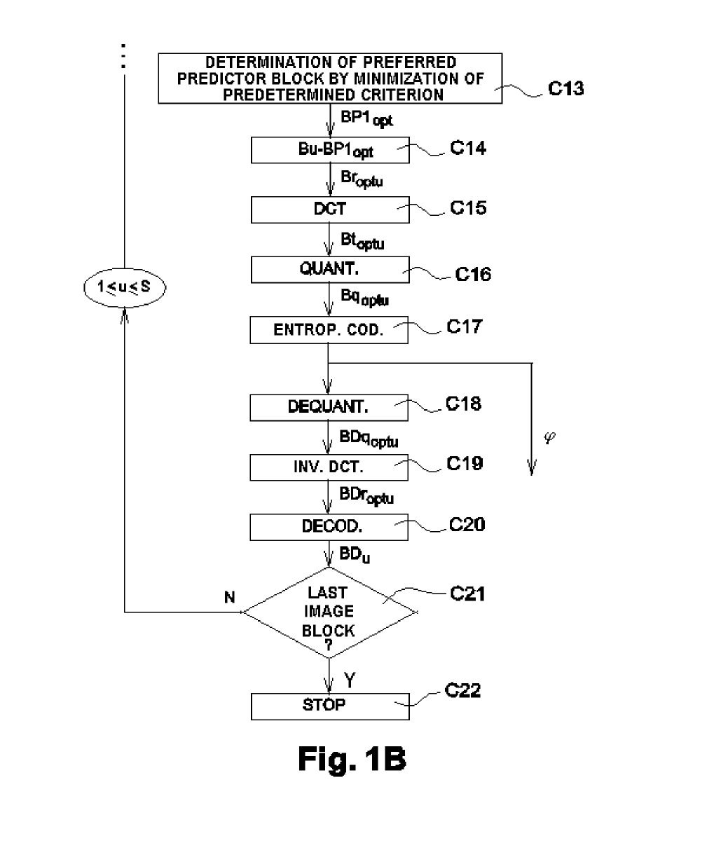

According to the embodiment of the invention, the coding method according to the invention is implemented in a coding device CO1 represented in FIG. 2.

As illustrated in FIG. 2, such a coding device comprises a memory MEM_CO1 comprising a buffer memory MT_CO1, a processing unit UT_CO1 equipped for example with a microprocessor μP and driven by a computer program PG_CO1 which implements the coding method according to the invention. On initialization, the code instructions of the computer program PG_CO1 are for example loaded into a RAM memory (not represented) before being executed by the processor of the processing unit UT_CO1.

The coding method represented in FIGS. 1A and 1B applies to any current image of a sequence SQ of images to be coded.

In the course of a first step C1 represented in FIG. 1A, there is undertaken, in a manner known per se, the partitioning of a current image ICⱼ belonging to the sequence SQ of images IC₁, . . . , ICⱼ, . . . , IC_{M} (1≦j≦M), into a plurality of blocks B₁, B₂, . . . , Bᵤ, . . . , B_{S} (1≦u≦S), for example 64×64 pixels in size. Such a partitioning step is implemented by a partitioning software module MP1 represented in FIG. 2, which module is driven by the microprocessor μP of the processing unit UT_CO1.

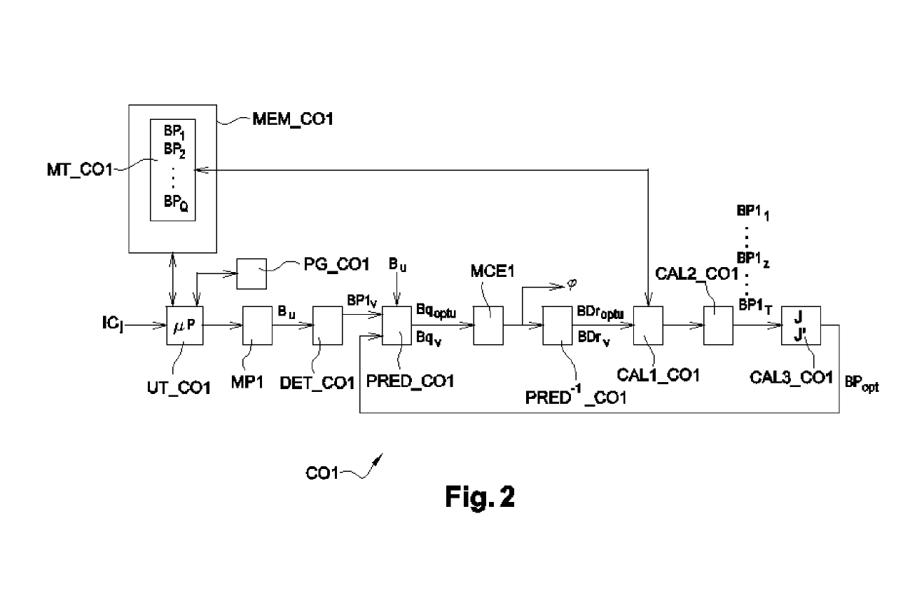

The image ICⱼ thus partitioned is represented in FIG. 3. In the example represented, the image ICⱼ is partitioned into four blocks B₁, B₂, B₃ and B₄.

It should be noted that within the meaning of the invention, the term “block” signifies coding unit. The latter terminology is in particular used in the HEVC standard, for example in the document “B. Bross, W.-J. Han, J.-R. Ohm, G. J. Sullivan, and T. Wiegand, “High efficiency video coding (HEVC) text specification draft 10,” document JCTVC-L1003 of JCT-VC, Geneva, CH, 14-23 January 2013”.

In particular, such a coding unit groups together sets of pixels of rectangular or square shape, also called blocks or macroblocks, or else sets of pixels exhibiting other geometric shapes.

Said blocks B₁, B₂, . . . , Bᵤ, . . . , B_{S} are intended to be coded according to a predetermined order of traversal, which is for example of the raster scan type. This signifies that the blocks are coded one after another, from left to right.

Other types of traversal are of course possible. Thus, it is possible to cut the image ICⱼ up into several sub-images called slices and to apply a cutting of this type to each sub-image independently. It is also possible to code not a succession of rows, as explained hereinabove, but a succession of columns. It is also possible to traverse the rows or columns in either direction.

In the course of a step C2 represented in FIG. 1A, the coder CO1 selects as current block a first block to be coded Bᵤ of the image ICⱼ, such as for example the first block B₁.

In the course of a step C3 represented in FIG. 1A, there is undertaken according to the invention the determination of a set of Q candidate predictor blocks BP1₁, BP1₂, . . . , BP1ᵥ, . . . , BP1_{Q} (1≦v≦Q) Such candidate predictor blocks are for example blocks of pixels which have or have not already been coded. Such blocks have previously been stored in the buffer memory MT_CO1 of the coder such as represented in FIG. 2. In the example represented, this entails in particular a predetermined number of blocks which have been coded just before the current block considered.

Such a determination step is implemented by a determination software module DET_CO1 represented in FIG. 2, which module is driven by the microprocessor μP of the processing unit UT_CO1.

In the course of a step C4 represented in FIG. 1A, for a candidate predictor block BP1ᵥ considered, there is undertaken the subtraction of the candidate predictor block BP1ᵥ from the current block Bᵤ to produce a residual block Brᵥ.

In the course of a step C5 represented in FIG. 1A, there is undertaken the transformation of the residual block Brᵥ according to a conventional direct transformation operation such as for example a discrete cosine transformation of DCT type, to produce a transformed block Btᵥ.

In the course of a step C6 represented in FIG. 1A, there is undertaken the quantization of the transformed block Btᵥ according to a conventional quantization operation, such as for example a scalar quantization. A block of quantized coefficients Bqᵥ is then obtained.

Steps C4 to C6 are implemented by a predictive coding software module PRED_CO1 represented in FIG. 2, which module is driven by the microprocessor μP of the processing unit UT_CO1. The predictive coding module PRED_CO1 is able to perform a predictive coding of the current block, according to conventional prediction techniques, such as for example in Intra and/or Inter mode.

In the course of a step C7 represented in FIG. 1A, there is undertaken the entropy coding of the block of quantized coefficients Bqᵥ. In the preferred embodiment, this entails a CABAC entropy coding. Such a step consists in:
a) reading the symbol or symbols of the predetermined set of symbols which are associated with said current block,
b) associating digital items of information, such as bits, with the symbol(s) read.

Such an entropy coding step is implemented by an entropy coding software module MCE1 represented in FIG. 2, which module is driven by the microprocessor μP of the processing unit UT_CO1. The entropy coding module MCE1 is for example of CABAC type. It may also be a Huffman coder known as such.

In the course of a step C8 represented in FIG. 1A, there is undertaken the dequantization of the block Bqᵥ according to a conventional dequantization operation, which is the operation inverse to the quantization performed in step C6. A block of dequantized coefficients BDqᵥ is then obtained.

In the course of a step C9 represented in FIG. 1A, there is undertaken the inverse transformation of the block of dequantized coefficients BDqᵥ which is the operation inverse to the direct transformation performed in step C5 hereinabove. A decoded residual block BDrᵥ is then obtained.

Steps C8 and C9 are implemented by an inverse predictive coding software module PRED⁻¹_CO1 represented in FIG. 2, which module is driven by the microprocessor μP of the processing unit UT_CO1.

Because, for the current block Bᵤ considered, steps C4 to C9 are repeated for each predictor block of the set of predictor blocks BP1₁, BP1₂, . . . , BP1ᵥ, . . . , BP1_{Q}, Q decoded residual blocks BDr₁, BDr₂, . . . , BDrᵥ, . . . , BDr_{Q} are obtained on completion of step C9.

In the course of a step C10 represented in FIG. 1A, there is undertaken according to the invention the identification, from among the set of Q predictor blocks BP1₁, BP1₂, . . . , BP1ᵥ, . . . , BP1_{Q}, of at least one predictor block capable of being retrieved when decoding the current block B. According to the invention, such an identification step is dependent on the current decoded residual block BDrᵥ obtained.

Such an identification step is implemented by a calculation software module CAL1_CO1 represented in FIG. 2, which module is driven by the microprocessor μP of the processing unit UT_CO1.

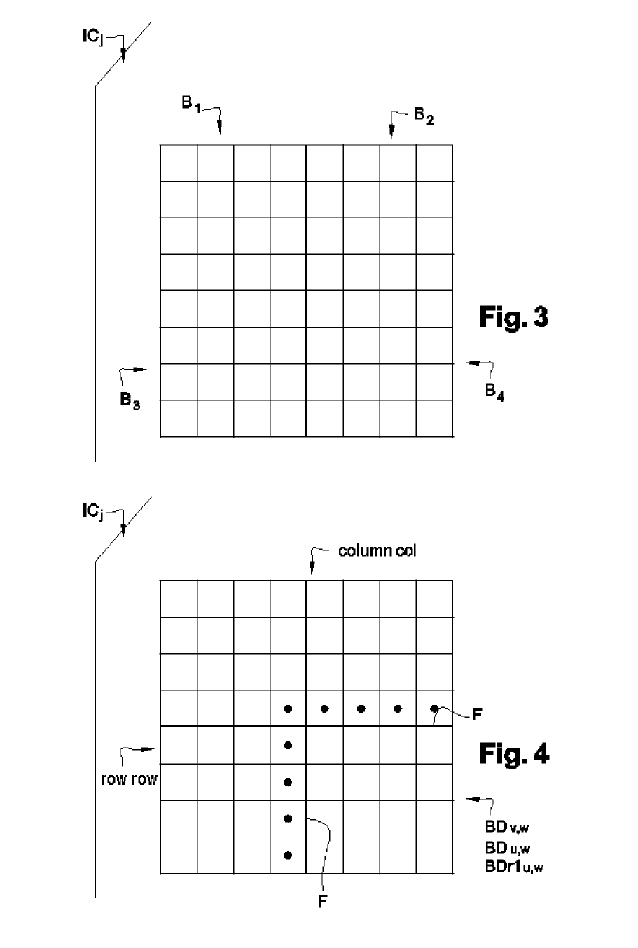

According to a particular embodiment represented in FIG. 4, such an identification consists, for a current decoded residual block BDrᵥ, in constructing a current decoded block BD_{v,w} by adding to the current decoded residual block BDrᵥ a candidate predictor block BP1_{w} (1≦w≦Q).

In this particular embodiment is applied a minimization criterion for the difference between the decoded pixels of the current image ICⱼ, which are represented by points in FIG. 4, and the pixels of the decoded block BD_{v,w} along its boundary F. This criterion is a mathematical operator denoted SM(BD_{v,w}, ICⱼ). The operator SM(BD_{v,w}, ICⱼ) is in fact representative of the quadratic error along the boundary F of the decoded residual block BDrᵥ with the image ICⱼ.

It may be written in the following manner:

$$SM ( {BD}_{v , w} , {IC}_{j} ) = {\sum }_{a = 0}^{N - 1} {( {BD}_{v , w} ( 0 , a ) - {IC}_{j} ( row - 1 , col + a ) )}^{2} + {\sum }_{a = 0}^{N - 1} {( {BD}_{v , w} ( a , 0 ) - {IC}_{j} ( row + a , col - 1 ) )}^{2}$$

where:
BD_{v,w} is the decoded block considered of size N×N pixels,
BD_{v,w}(n,m) is the value of the pixel of the decoded residual block BD_{v,w} situated in the nth row and the mth column of this block,
ICⱼ is the current image,
ICⱼ(k,l) is the value of the pixel of the image ICⱼ situated in the kth row and the Ith column of this image, and (row,col) are the coordinates of the decoded block BD_{v,w} in the image ICⱼ.

By way of alternative, it is possible to use a simplified criterion, where one compares the average of the pixels of the image ICⱼ along the boundary F and the average of the pixels of the decoded block BD_{v,w}. The operator SM(BD_{v,w}, ICⱼ) may then be written:

$$SM ( {BD}_{v , w} , {IC}_{j} ) = abs ( \frac{1}{( 2 N - 1 )} {\sum }_{a = 0}^{N - 1} ( {IC}_{j} ( row - 1 , col + a ) + {IC}_{j} ( row + a , col - 1 ) ) - \frac{1}{{N}^{2}} {\sum }_{a = 0}^{N - 1} {\sum }_{b = 0}^{N - 1} ( {BD}_{v , w} ( a , b ) ) )$$

where abs( ) represents the absolute value.

In the course of step C10, there is undertaken the determination of the decoded block BD_{v,wmin} which minimizes one of the two aforementioned chosen criteria, such that:

Kmin=argmin_{K}SM(BD_{uK}, PDICⱼ)

The block BD_{v,wmin} is equal to the sum of the candidate predictor block BP1_{wmin} and of the current decoded residual block BDrᵥ.

In the course of a step C11 represented in FIG. 1A, there is undertaken the comparison of the identified candidate predictor block BP1_{wmin} with the candidate predictor block BP1ᵥ associated with the decoded residual block BDrᵥ.

Such a comparison step is implemented by a calculation software module CAL2_CO1 represented in FIG. 2, which module is driven by the microprocessor μP of the processing unit UT_CO1.

For the current block Bᵤ considered, steps C4 to C11 are repeated for each predictor block of the set of predictor blocks BP1₁, BP1₂, . . . , BP1ᵥ, . . . , BP1_{Q}determined in step C3.

In the case where there is identity between the block BP1_{wmin} and the block BP1ᵥ, there is undertaken, in the course of a step C12a) represented in FIG. 1A, the selection of the block BP1_{wmin} which becomes an identified predictor block.

In the case where there is no identity between the block BP1_{wmin} and the block BP1ᵥ, the block BP1_{wmin} is not selected as identified predictor block.

On completion of the selection step C12a), a plurality T of identified predictor blocks BP1₁, BP1₂, . . . , BP1_{z}, . . . , BP1_{T} is obtained, where 1≦z≦T≦Q.

In the course of a step C13 represented in FIG. 1B, there is undertaken the determination, from among all the predictor blocks BP1₁, BP1₂, . . . , BP1_{z}, . . . , BP1_{T} which have been obtained in step C12a), of a preferential candidate predictor block BP1ₒₚₜ, with the aid of the minimization of a predetermined criterion. Such a criterion is expressed by equation (1) hereinbelow:

J=D+λR (1) where

D represents the distortion between the original current block B₁ and the reconstructed block B₁, R represents the cost in bits of the coding of the coding parameters used to code the block B₁ and λ represents a Lagrange multiplier whose value is fixed at the coder.

According to a variant which is particularly advantageous from the point of view of reducing the calculation time at the coder, the predetermined performance criterion depends only on the distortion and is expressed by equation (2) hereinbelow:

J′=D. (2)

The criteria J and J′ are conventionally calculated by simulation by a calculation module CAL3_CO1 represented in FIG. 2, which module is driven by the microprocessor μP of the processing unit UT_CO1.

In the course of a step C14 represented in FIG. 1B, the predictive module PRED_CO1 of FIG. 2 undertakes the subtraction of the preferential candidate predictor block BP1ₒₚₜ from the current block Bᵤ to produce a residual block Brₒₚₜᵤ.

In the course of a step C15 represented in FIG. 1B, the module PRED_CO1 of FIG. 2 undertakes the transformation of the residual block Brₒₚₜᵤ according to a conventional direct transformation operation such as for example a discrete cosine transformation of DCT type, to produce a transformed block Btₒₚₜᵤ.

In the course of a step C16 represented in FIG. 1B, the module PRED_CO1 of FIG. 2 undertakes the quantization of the transformed block Btₒₚₜᵤ according to a conventional quantization operation, such as for example a scalar quantization. A block of quantized coefficients Bqₒₚₜᵤ is then obtained.

In the course of a step C17 represented in FIG. 1B, the entropy coding module MCE1 of FIG. 2 undertakes the entropy coding of the block of quantized coefficients Bqₒₚₜᵤ.

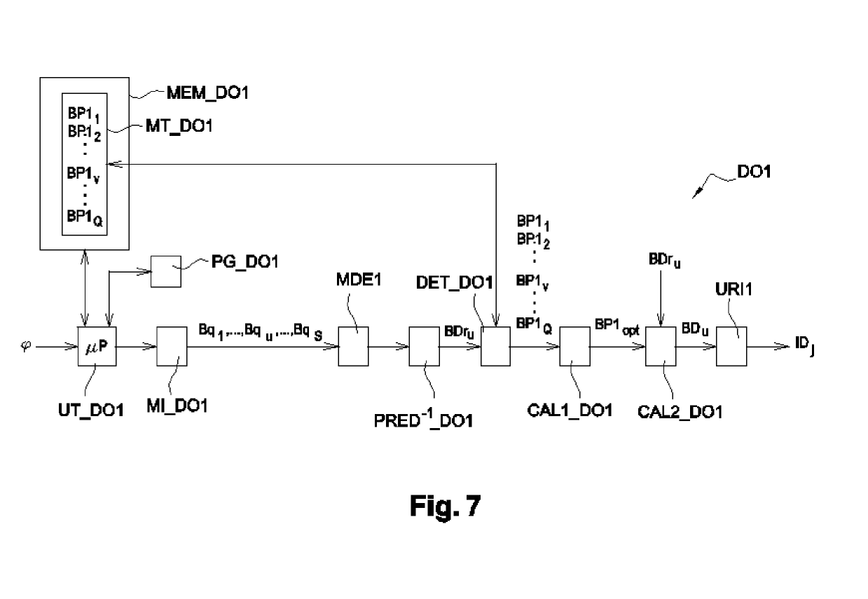

A data stream φ which contains the encoded data of the block of quantized coefficients Bqₒₚₜᵤ is then delivered on completion of step C17. Such a stream is thereafter transmitted by a communication network (not represented), to a remote terminal. The latter comprises the decoder DO1 represented in FIG. 7. In a manner known per se, the stream φ furthermore comprises certain items of information encoded by the coder CO1, such as the type of prediction (inter or intra) and, if appropriate, the mode of prediction, the type of partitioning of the block if the latter has been partitioned, the reference image index and the displacement vector which are used in the inter prediction mode.

In the course of a step C18 represented in FIG. 1B, the module PRED⁻¹_CO1 of FIG. 2 undertakes the dequantization of the block Bqₒₚₜᵤ according to a conventional dequantization operation, which is the operation inverse to the quantization performed in step C16. A block of dequantized coefficients BDqₒₚₜᵤ is then obtained.

In the course of a step C19 represented in FIG. 1B, the module PRED⁻¹_CO1 of FIG. 2 undertakes the inverse transformation of the block of dequantized coefficients BDqₒₚₜᵤ which is the operation inverse to the direct transformation performed in step C15 hereinabove. A decoded residual block BDrₒₚₜᵤ is then obtained.

In the course of a step C20 represented in FIG. 1B, there is undertaken the construction of the decoded block BDᵤ by adding to the preferential candidate predictor block BP1 ₒₚₜ the decoded residual block BDrₒₚₜᵤ. It should be noted that the latter block is the same as the decoded block obtained on completion of the method for decoding the image ICⱼ which will be described further on in the description. The decoded block BDᵤ is then stored in the buffer memory MT_CO1 of FIG. 2, so as to be used by the coder CO1 as candidate predictor block of a following block to be coded.

In the course of a step C21 represented in FIG. 1B, the coder CO1 tests whether the current block Bᵤ which has just been coded is the last block of the image ICⱼ.

If the current block is the last block of the image ICⱼ, in the course of a following step C22 represented in FIG. 1B, the coding method is terminated.

If such is not the case, there is again undertaken the step of selection C2 of the following block to be coded in accordance with the aforementioned raster scan order of traversal, and then steps C3 to C21 are repeated for this selected following block.

The coding steps which have just been described hereinabove are implemented for all the blocks B₁, B₂, . . . , Bᵤ, . . . , B_{S} to be coded of the current image ICⱼ considered.

### Detailed Description of Another Embodiment of the Coding Part

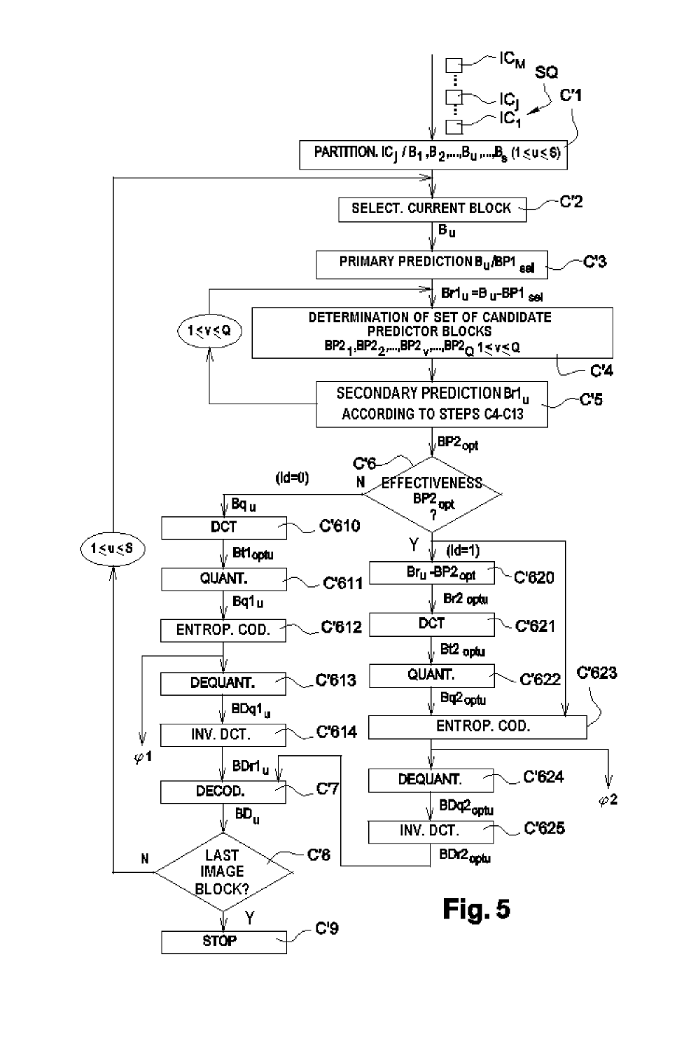

This other embodiment is distinguished from the previous embodiment in that it implements two types of prediction which will be described hereinbelow with reference to FIG. 5. The coding method according to this other embodiment is represented in the form of an algorithm comprising steps C′1 to C′9 such as represented in FIG. 5.

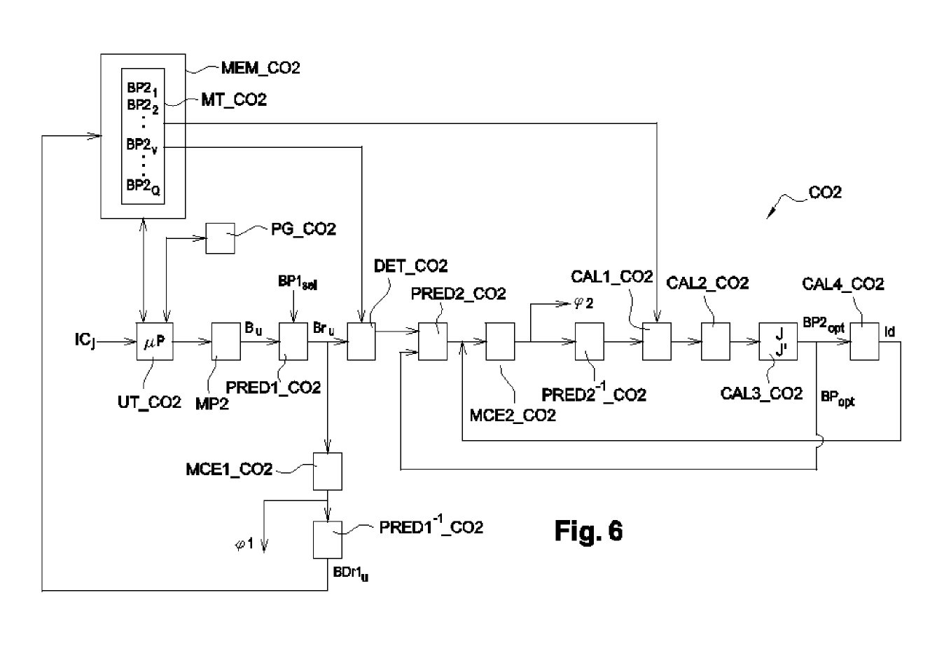

The coding method according to this other embodiment of the invention is implemented in a coding device CO2 represented in FIG. 6.

As illustrated in FIG. 6, such a coding device CO2 comprises a memory MEM_CO2 comprising a buffer memory MT_CO2, a processing unit UT_CO2 equipped for example with a microprocessor μP and driven by a computer program PG_CO2 which implements the coding method according to this other embodiment. On initialization, the code instructions of the computer program PG_CO2 are for example loaded into a RAM memory (not represented) before being executed by the processor of the processing unit UT_CO2.

The coding method represented in FIG. 5 applies to any current image of a sequence SQ of images to be coded.

In the course of a step C′1 represented in FIG. 5, there is undertaken the partitioning of a current image ICj belonging to the sequence SQ of images IC1, . . . , ICj, . . . , ICM (1≦j≦M) into a plurality of blocks B1, B2, Bu, . . . , BS (1≦u≦S), for example 64×64 pixels in size. Such a partitioning step is implemented by a partitioning software module MP2 represented in FIG. 6, which module is driven by the microprocessor μP of the processing unit UT_CO2. Step C′1 being identical to step Cl of FIG. 1A, it will not be described at greater length.

As in the embodiment of FIGS. 1A and 1B, said blocks B₁, B₂, . . . , Bᵤ, . . . , Bs are intended to be coded according to a predetermined order of traversal, which is for example of the raster scan type. This signifies that the blocks are coded one after another, from left to right.

In the course of a step C′2 represented in FIG. 5, the coder CO2 selects as current block a first block to be coded Bᵤ of the image ICⱼ, such as for example the first block B₁.

In the course of a step C′3 represented in FIG. 5, there is undertaken, in a manner known per se, the prediction of the current block Bᵤ by conventional techniques of intra and/or inter prediction with the aid of a predictor block BP1ₛₑₗ. Such a prediction will be called “primary prediction” in the subsequent description.

The aforementioned prediction step makes it possible to construct a residual block Br1ᵤ which is obtained by calculating the difference between the current block Bᵤ and the predictor block BP1ₛₑₗ.

Step C′3 is implemented by a predictive coding software module PRED1_CO2 represented in FIG. 6, which module is driven by the microprocessor μP of the processing unit UT_CO2.

In the course of a step C′4 represented in FIG. 5, in accordance with the invention, there is undertaken the determination of a set of Q candidate predictor blocks BP2₁, BP2₂, . . . , BP2ᵥ, . . . , BP2_{Q} (1≦v≦Q). Such a step being identical to the determination step C3 of FIG. 1A, it will not be described at greater length.

Such a determination step C′4 is implemented by a determination software module DET_CO2 represented in FIG. 6, which module is driven by the microprocessor μP of the processing unit UT_CO2.

In the course of a step C′5 represented in FIG. 5, in accordance with the invention, there is undertaken a prediction of the residual block Br1ᵤ by implementing steps C4 to C13 described hereinabove in conjunction with FIGS. 1A and 1B. Such a prediction will be called “secondary prediction” in the subsequent description.

In the course of this secondary prediction, a preferential candidate predictor block BP2ₒₚₜ is selected.

With reference to FIG. 6, step C′5 is implemented with the aid:
of a prediction software module PRED2_CO2 which is identical to the module PRED_CO1 of FIG. 2,
of an entropy coding software module MCE2_CO2 which is identical to the module MCE1 of FIG. 2,
of an inverse prediction software module PRED2⁻¹_CO2 which is identical to the module PRED⁻¹_CO1 of FIG. 2,
of a calculation software module CAL1_CO2 which is identical to the module CAL1_CO1 of FIG. 2,
of a calculation software module CAL2_CO2 which is identical to the module CAL2_CO1 of FIG. 2.

In the course of a step C′6 represented in FIG. 5, in accordance with the invention, there is undertaken the testing of the effectiveness of the preferential candidate predictor block BP2ₒₚₜ which has been selected.

The test step C′6 is implemented by a calculation software module CAL4_CO2 represented in FIG. 6, which module is driven by the microprocessor μP of the processing unit UT_CO2.

In a preferred embodiment, such a test consists in verifying whether the energy of the block Br1ᵤ-BP2ₒₚₜ is less than a threshold which corresponds to the value of the energy of the block Br1ᵤ.

If the test is negative, the coding of the current block Bᵤ continues in a conventional manner.

If the test is positive, this signifies that the preferential candidate predictor block BP2ₒₚₜ is close to the current original block B. Consequently, the secondary prediction is applied to the current block Bᵤ.

Negative Test

In the case where the test performed in step C′6 is negative, in the course of a step C′610 represented in FIG. 5, there is undertaken the transformation of the residual block Br1ᵤ according to a conventional direct transformation operation such as for example a discrete cosine transformation of DCT type, to produce a transformed block Bt1ᵤ.

In the course of a step C′611 represented in FIG. 5, there is undertaken the quantization of the transformed block Bt1ᵤ according to a conventional quantization operation, such as for example a scalar quantization. A block of quantized coefficients Bq1ᵤ is then obtained.

Steps C′610 and C′611 are implemented by the predictive coding software module PRED1_CO2 represented in FIG. 6.

In the course of a step C′612 represented in FIG. 5, there is undertaken the entropy coding of the block of quantized coefficients Bq1ᵤ by an entropy coding software module MCE1_CO2 identical to the entropy coding software module MCE1 of FIG. 2. Furthermore, an indicator Id associated with the preferential candidate predictor block BP2ₒₚₜ is coded according to a first predetermined value (bit set to 0 for example) to signal that the secondary prediction has not been applied.

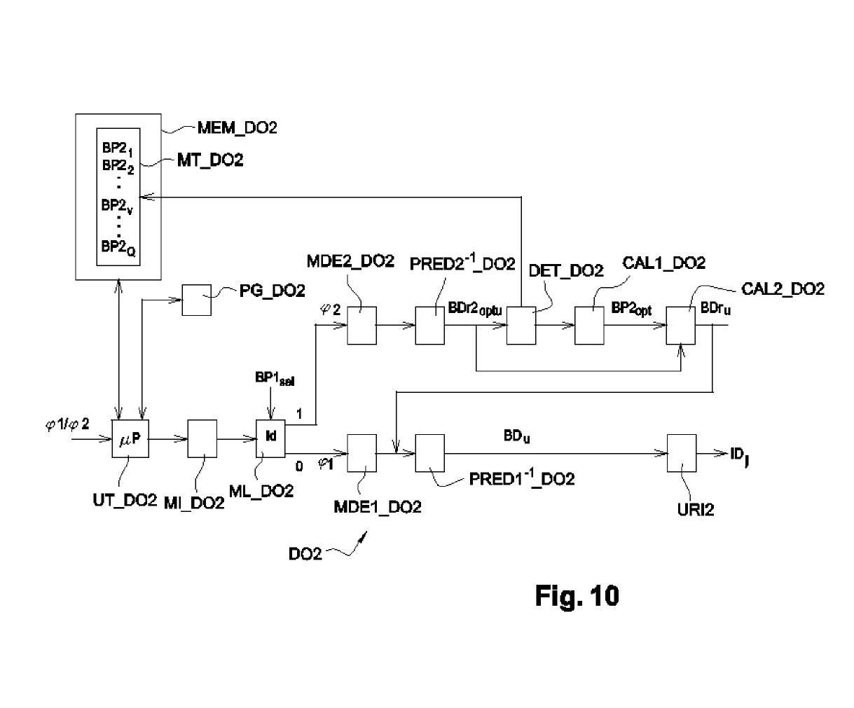

A data stream (φ1, which contains the encoded data of the block of quantized coefficients Bq1₁ as well as the bit set to 0 of the indicator Id, is then delivered on completion of step C′612. Such a stream is thereafter transmitted by a communication network (not represented), to a remote terminal. The latter comprises the decoder DO2 represented in FIG. 10. In a manner known per se, the stream φ1 contains items of information encoded by the coder CO2, such as the type of prediction (inter or intra), and if appropriate, the mode of prediction, the type of partitioning of a block or macroblock if the latter has been partitioned, the reference image index and the displacement vector which are used in the inter prediction mode.

In the course of a step C′613 represented in FIG. 5, there is undertaken the dequantization of the block Bq1ᵤ according to a conventional dequantization operation, which is the operation inverse to the quantization performed in step C′611. A block of dequantized coefficients BDq1ᵤ is then obtained.

In the course of a step C′614 represented in FIG. 5, there is undertaken the inverse transformation of the block of dequantized coefficients BDq1ᵤ which is the operation inverse to the direct transformation performed in step C′610 hereinabove. A decoded residual block BDr1ᵤ is then obtained.

Steps C′613 and C′614 are implemented by an inverse predictive coding software module PRED1⁻¹₁₃ CO2 represented in FIG. 6, which module is driven by the microprocessor μP of the processing unit UT_CO2. Such a module is identical to the software module PRED⁻¹_CO1 of FIG. 2.

In the course of a step C′7 represented in FIG. 5, there is undertaken the construction of the decoded block BDᵤ by adding to the predictor block BP1ₛₑₗ, the decoded residual block BDr1ᵤ. The decoded block BDᵤ is then stored in the buffer memory MT_CO2 of FIG. 6, so as to be used by the coder CO2 as candidate predictor block in a secondary prediction of a following decoded residual block.

In the course of a step C′8 represented in FIG. 5, the coder CO2 tests whether the current block Bᵤ which has just been coded is the last block of the image ICⱼ.

If the current block Bᵤ is the last block of the image ICⱼ, in the course of a step C′9 represented in FIG. 5, the coding method is terminated.

If such is not the case, there is again undertaken the step of selection C′2 of the following block to be coded in accordance with the aforementioned raster scan order of traversal, and then steps C′3 to C′6 are repeated for this selected following block.

Positive Test

If the test performed in step C′6 is positive, in the course of a step C′620 represented in FIG. 5, the module PRED2_CO2 of FIG. 6 undertakes the subtraction of the preferential candidate predictor block BP2ₒₚₜ from the residual block Br1ᵤ to produce a residual block Br2ₒₚₜᵤ.

In the course of a step C′621 represented in FIG. 5, the module PRED2_CO2 of FIG. 6 undertakes the transformation of the residual block Br2ₒₚₜᵤ according to a conventional direct transformation operation such as for example a discrete cosine transformation of DCT type, to produce a transformed block Bt2ₒₚₜᵤ.

In the course of a step C′622 represented in FIG. 5, the module PRED2_CO2 of FIG. 6 undertakes the quantization of the transformed block Bt2ₒₚₜᵤ according to a conventional quantization operation, such as for example a scalar quantization. A block of quantized coefficients Bq2ₒₚₜᵤ is then obtained.

In the course of a step C′623 represented in FIG. 5, the entropy coding module MCE2_CO2 of FIG. 6 undertakes the entropy coding of the block of quantized coefficients Bq2ₒₚₜᵤ. Furthermore, the indicator Id associated with the preferential candidate predictor block BP2ₒₚₜ is coded according to a second predetermined value (bit set to 1 for example) to signal that the secondary prediction has been applied.

A data stream (φ2, which contains the encoded data of the block of quantized coefficients Bq2ₒₚₜᵤ as well as the bit set to 1 of the indicator Id, is then delivered on completion of step C′623. Such a stream is thereafter transmitted by a communication network (not represented) to the decoder DO2 represented in FIG. 10.

In the course of a step C′624 represented in FIG. 5, the module PRED2⁻¹_CO2 of FIG. 6 undertakes the dequantization of the block Bq2ₒₚₜᵤ according to a conventional dequantization operation, which is the operation inverse to the quantization performed in step C′622. A block of dequantized coefficients BDq2ₒₚₜᵤ is then obtained.

In the course of a step C′625 represented in FIG. 5, the module PRED2⁻¹_CO2 of FIG. 6 undertakes the inverse transformation of the block of dequantized coefficients BDq2ᵤₚₜᵤ which is the operation inverse to the direct transformation performed in step C′621 hereinabove. A decoded residual block BDr2ₒₚₜᵤ is then obtained.

In the course of step C′7 mentioned above, there is undertaken the construction of the decoded block BDᵤ by adding to the preferential candidate predictor block BP2ₒₚₜ the decoded residual block BDr2ₒₚₜᵤ. The decoded block BDᵤ thus constructed is then stored in the buffer memory MT_CO2 of FIG. 6, so as to be used by the coder CO2 as candidate predictor block in a secondary prediction of a following decoded residual block.

In the course of step C′8 represented in FIG. 5, the coder CO2 tests whether the current block Bᵤ which has just been coded is the last block of the image ICⱼ.

If the current block is the last block of the image ICⱼ, in the course of step C′9 represented in FIG. 5, the coding method is terminated.

If such is not the case, there is again undertaken the step of selection C′2 of the following block to be coded in accordance with the aforementioned raster scan order of traversal, and then steps C′3 to C′6 are repeated for this selected following block.

The coding steps which have just been described hereinabove are implemented for all the blocks B₁, B₂, . . . , Bᵤ, . . . , B_{S} to be coded of the current image ICⱼ considered.

### Detailed Description of an Embodiment of the Decoding Part

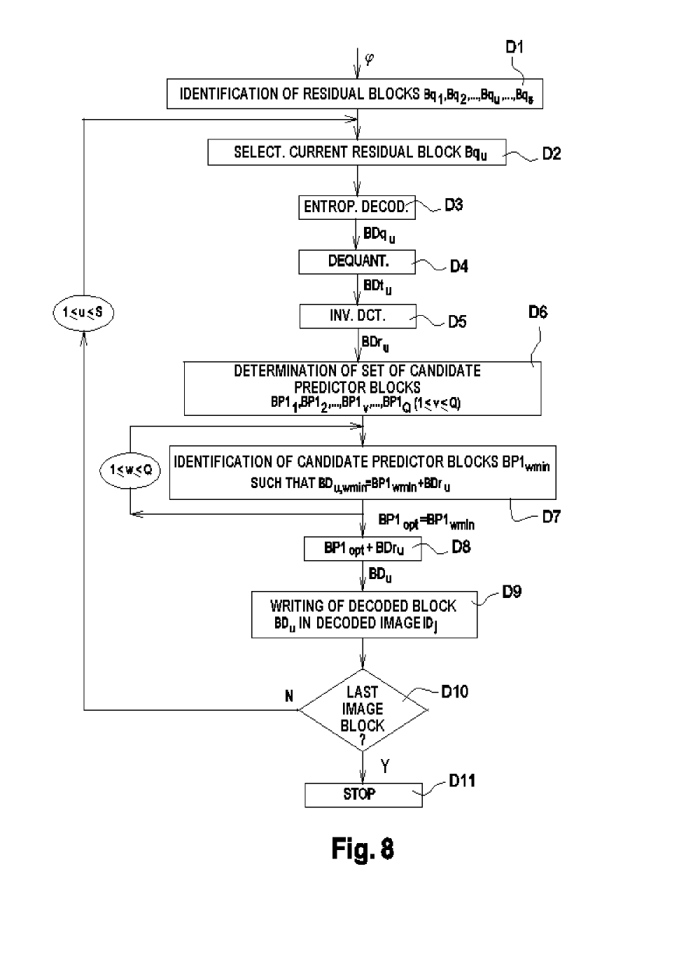

An embodiment of the decoding method according to the invention will now be described, in which the decoding method is implemented in a software or hardware manner by modifications of a decoder initially complying with the HEVC standard. The decoding method according to the invention is represented in the form of an algorithm comprising steps D1 to D11 such as represented in FIG. 8.

As illustrated in FIG. 7, a decoder DO1 according to the invention comprises a memory MEM_DO1 comprising a buffer memory MT_DO1, a processing unit UT_DO1 equipped for example with a microprocessor μP and driven by a computer program PG_DO1 which implements the decoding method according to the invention. On initialization, the code instructions of the computer program PG_DO1 are for example loaded into a RAM memory before being executed by the processor of the processing unit UT_DO1.

The decoding method represented in FIG. 8 applies to any current image of a sequence SQ of images to be decoded.

For this purpose, items of information representative of the current image ICⱼ to be decoded are identified in the stream φ received at the decoder.

With reference to FIG. 8, the first decoding step D1 is the identification in said stream φ of the encoded data Bq₁, Bq₂, . . . , Bq ᵤ, . . . Bq_{S} associated respectively with the residual blocks Br₁, Br₂, . . . , Brᵤ, . . . , Br_{S} previously coded in accordance with the aforementioned raster scan traversal, according to the coding method represented in FIGS. 1A and 1B.

Such an identification step is implemented by an identification module MI_DO1 such as represented in FIG. 8, said module being driven by the microprocessor μP of the processing unit UT_DO1.

Said blocks Bq₁, Bq₂, . . . , Bqᵤ, . . . , Bq_{S} are intended to be decoded according to a predetermined order of traversal, which is for example of the sequential type, that is to say that they are intended to be decoded one after the other in the raster scan order in which they have been coded.

Other types of traversal than that which has just been described hereinabove are of course possible and depend on the order of traversal chosen when coding, some examples of which have been mentioned above.

In the course of a step D2 represented in FIG. 8, the decoder DO1 selects as current block a first block to be decoded Bqᵤ of the image ICⱼ, such as for example the first block Bq₁.

In the course of a step D3 represented in FIG. 8, there is undertaken the entropy decoding of the block Bqᵤ. In the preferred embodiment, this entails a CABAC entropy decoding. Such a step consists in:
a) reading the symbol or symbols of the predetermined set of symbols which are associated with said current residual block,
b) associating digital items of information, such as bits, with the symbol(s) read.

Such an entropy decoding step is implemented by an entropy decoding software module MDE1 represented in FIG. 7, which module is driven by the microprocessor μP of the processing unit UT_DO1. The entropy decoding module MDE1 is for example of CABAC type. It may also be a Huffman decoder known as such.

In the course of a step D4 represented in FIG. 8, there is undertaken the dequantization of the block BDqᵤ according to a conventional dequantization operation, which is the operation inverse to the quantization performed in step C16 of FIG. 1B. A decoded dequantized block BDt_{U} is then obtained.

In the course of a step D5 represented in FIG. 8, there is undertaken the inverse transformation of the decoded dequantized block BDt_{U} which is the operation inverse to the direct transformation performed in step C15 of FIG. 1B. A decoded residual block BDrᵤ is then obtained.

Steps D4 and D5 are implemented by an inverse predictive decoding software module PRED⁻¹_DO1 represented in FIG. 7, which module is driven by the microprocessor μP of the processing unit UT_DO1.

In the course of a step D6 represented in FIG. 8, there is undertaken according to the invention the determination of a set of Q candidate predictor blocks BP1₁, BP1₂, . . . , BP1ᵥ, . . . , BP1_{Q} (1≦v≦Q). Such candidate predictor blocks are for example blocks of pixels which have or have not already been decoded.

Such blocks have previously been stored in the buffer memory MT_DO1 of the decoder such as represented in FIG. 7. In the example represented, this entails in particular a predetermined number of blocks which have been decoded just before the current block to be decoded considered.

Such a determination step is implemented by a determination software module DET_DO1 represented in FIG. 7, which module is driven by the microprocessor μP of the processing unit UT_DO1.

In the course of a step D7 represented in FIG. 8, there is undertaken according to the invention the identification, from among the set of Q predictor blocks BP1₁, BP1₂, . . . , BP1ᵥ, . . . , BP1_{Q}, of a preferential candidate predictor block BP1ₒₚₜ. According to the invention, in the same manner as during the aforementioned coding, such an identification step is dependent on the decoded residual block BDrᵤ obtained.

Said identification step is implemented by a calculation software module CAL1_DO1 represented in FIG. 7, which module is driven by the microprocessor μP of the processing unit UT_DO1.

In the same manner as in the coding method described with reference to FIGS. 1A and 1B, such an identification consists, for a current decoded residual block BDrᵤ, in constructing a current decoded block BD_{u,w} by adding to the current decoded residual block BDrᵤ a candidate predictor block BP1_{w} (1≦w≦Q).

In this particular embodiment, and in a manner corresponding to the coding, is applied a minimization criterion for the difference between the decoded pixels of the current image ICⱼ, which are represented by points in FIG. 4, and the pixels of the decoded block BD_{u,w} situated along its boundary F. This criterion is a mathematical operator denoted SM(BD_{u,w}, ICⱼ). The operator SM(BD_{u,w}, ICⱼ) is in fact representative of the quadratic error along the boundary F of the decoded residual block BDrᵤ with the image ICⱼ.

It may be written in the following manner:

$$SM ( {BD}_{u , w} , {IC}_{j} ) = {\sum }_{a = 0}^{N - 1} {( {BD}_{u , w} ( 0 , a ) - {IC}_{j} ( row - 1 , col + a ) )}^{2} + {\sum }_{a = 0}^{N - 1} {( {BD}_{u , w} ( a , 0 ) - {IC}_{j} ( row + a , col - 1 ) )}^{2}$$

where:
BD_{u,w} is the decoded block considered of size N×N pixels,
BD_{u,w}(n,m) is the value of the pixel of the decoded residual block BD_{u,w} situated in the nth row and the mth column of this block,
ICⱼ is the current image,
ICⱼ(k,l) is the value of the pixel of the image ICⱼ situated in the kth row and the Ith column of this image, and (row,col) are the coordinates of the decoded block BD_{u,w} in the image ICⱼ.

By way of alternative, it is possible to use a simplified criterion, where one compares the average of the pixels of the image ICⱼ along the boundary F and the average of the pixels of the decoded block BD_{u,w}. The operator SM(BD_{u,w}, ICⱼ) may then be written:

$$SM ( {BD}_{u , w} , {IC}_{j} ) = abs ( \frac{1}{( 2 N - 1 )} {\sum }_{a = 0}^{N - 1} ( {IC}_{j} ( row - 1 , col + a ) + {IC}_{j} ( row + a , col - 1 ) ) - \frac{1}{{N}^{2}} {\sum }_{a = 0}^{N - 1} {\sum }_{b = 0}^{N - 1} ( {BD}_{u , w} ( a , b ) ) )$$

where abs( ) represents the absolute value.

In the course of step D7, there is undertaken the identification of the decoded block BD_{v,wmin} which minimizes one of the two aforementioned chosen criteria, such that:

wmin=argmin_{w} SM(BD_{u,w},ICⱼ)

The block BD_{v,wmin} is equal to the sum of the candidate predictor block BP1_{wmin} and of the current decoded residual block BDrᵥ.

On completion of step D7, the candidate predictor block BP1_{wmin} is considered to be the candidate preferential predictor block BP1ₒₚₜ with a view to the inverse prediction of the current decoded residual block BDrᵤ.

In the course of a step D8 represented in FIG. 8, there is undertaken the reconstruction of the current block Bᵤ by adding to the decoded current residual block BDrᵤ the preferential candidate predictor block BP1ₒₚₜ identified in step D7.

Said step D8 is implemented by a calculation software module CAL2_DO1 represented in FIG. 7, which module is driven by the microprocessor μP of the processing unit UT_DO1.

A decoded block BDᵤ is then obtained and stored in the buffer memory MT_DO1 of FIG. 7, so as to be used by the decoder DO1 as candidate predictor block of a following block to be decoded.

In the course of a step D9 represented in FIG. 8, said decoded block BDᵤ is written in a decoded image IDⱼ. Such a step is implemented by an image reconstruction software module URI1 such as represented in FIG. 7, said module being driven by the microprocessor μP of the processing module UT_DO1.

In the course of a following step D10 represented in FIG. 8, the decoder DO1 tests whether the current block BDᵤ which has just been decoded is the last block contained in the stream φ.

If such is the case, in the course of a step D11 represented in FIG. 8, the decoding method is terminated.

If such is not the case, there is undertaken, in the course of step D2, the selection of the following residual block to be decoded in accordance with the aforementioned raster scan order of traversal.

The decoding steps which have just been described hereinabove are implemented for all the blocks Bq₁, Bq₂, . . . , Bqᵤ, . . . , Bq_{S} to be decoded of the current image ICⱼ considered.

### Detailed Description of Another Embodiment of the Decoding Part

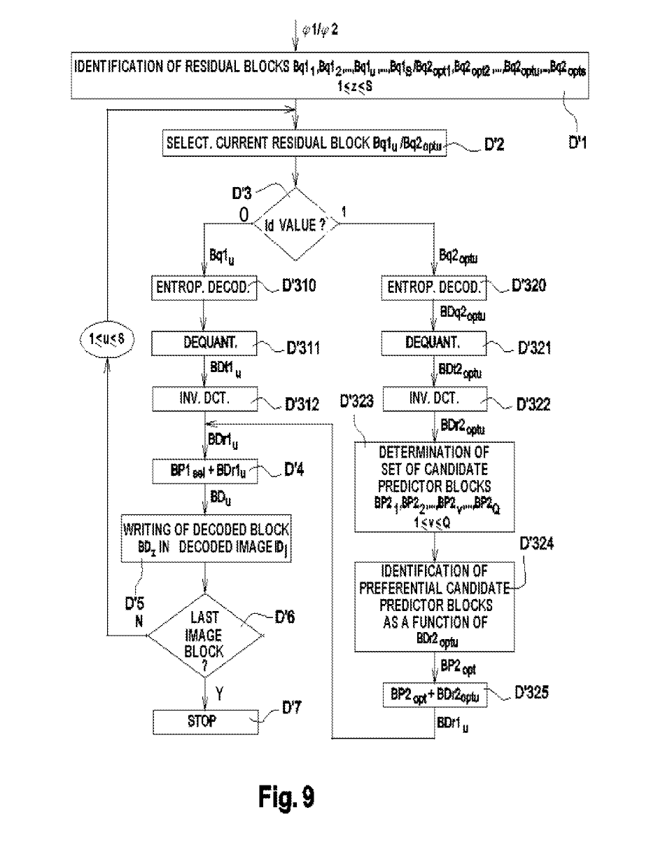

Another embodiment of the decoding method according to the invention will now be described, in which the decoding method is implemented in a software or hardware manner by modifications of a decoder initially complying with the HEVC standard. The decoding method according to the invention is represented in the form of an algorithm comprising steps D′1 to D′7 such as represented in FIG. 9.

As illustrated in FIG. 10, a decoder DO2 according to this other embodiment of the invention comprises a memory MEM_DO2 comprising a buffer memory MT_DO2, a processing unit UT_DO2 equipped for example with a microprocessor μP and driven by a computer program PG_DO2 which implements the decoding method according to the invention. On initialization, the code instructions of the computer program PG_DO2 are for example loaded into a RAM memory before being executed by the processor of the processing unit UT_DO2.

The decoding method represented in FIG. 9 applies to any current image of a sequence SQ of images to be decoded.

For this purpose, items of information representative of the current image ICⱼ to be decoded are identified in a data stream φ1 or φ2 received at the decoder, such as delivered subsequent to the coding method of FIG. 5.

With reference to FIG. 9, the first decoding step D′1 is the identification:
in said stream φ1 of the encoded data Bq1₁, Bq1₂, . . . , Bq1ᵤ, . . . Bq1_{S} (1≦u≦S) associated respectively with the residual blocks Br1₁, Br1₂, . . . , Br1ᵤ, . . . , Br1_{S} previously coded in accordance with the aforementioned raster scan traversal, in the case where the primary prediction of the coding method of FIG. 5 has been implemented,
in said stream φ2 of the encoded data Bq2ₒₚₜ₁, Bq2ₒₚₜ₂, . . . , Bq2ₒₚₜᵤ, . . . Bq2_{optS} (1≦u≦S) associated respectively with the residual blocks Br2ₒₚₜ₁, Br2ₒₚₜ₂, . . . , Br2ₒₚₜᵤ, . . . , Br2_{optS} previously coded in accordance with the aforementioned raster scan traversal, in the case where the secondary prediction of the coding method represented in FIG. 5 has been implemented.

Such an identification step is implemented by an identification module MI_DO2 such as represented in FIG. 10, said module being driven by the microprocessor μP of the processing unit UT_DO2.

Said blocks Bq1₁, Bq1₂, . . . , Bq1ᵤ, . . . , Bq1_{S} or Bq2ₒₚₜ₁, Bq2ₒₚₜ₂, . . . , Bq2ₒₚₜᵤ, . . . Bq2_{optS} are intended to be decoded according to a predetermined order of traversal, which is for example sequential, that is to say that the blocks are intended to be decoded one after the other in accordance with the raster scan order in which they have been coded.

Other types of traversal than that which has just been described hereinabove are of course possible and depend on the order of traversal chosen when coding, some examples of which have been mentioned above.

In the course of a step D′2 represented in FIG. 9, the decoder DO2 selects as current block a first block to be coded Bq1ᵤ or Bq2ₒₚₜᵤ of the image ICⱼ, such as for example the first block Bq1ᵤ or Bq2ₒₚₜᵤ.

In the course of a step D′3 represented in FIG. 9, there is undertaken the reading, in the stream φ1 or φ2, of the index Id associated with the block Bqᵤ selected.

Such a reading step is implemented by a reading software module MI_DO2 such as represented in FIG. 10, said module being driven by the microprocessor μP of the processing unit UT_DO2.

If the index Id is equal to zero, this signifies that the current block to be decoded has undergone a primary prediction in accordance with steps C′610 to C′614 of the coding method represented in FIG. 5. It is therefore the stream φ1 that the decoder DO2 is intended to process.

If the index Id is equal to one, this signifies that the current block to be decoded has undergone a secondary prediction in accordance with steps C′5 to C′625 of the coding method represented in FIG. 5. It is therefore the stream φ2 that the decoder DO2 is intended to process.

### Case Where Id=0

In the course of a step D′310 represented in FIG. 9, there is undertaken the entropy decoding of the block Bq1ᵤ. Such a step being identical to the aforementioned step D3, it will not be described at greater length.

Such an entropy decoding step is implemented by an entropy decoding software module MDE1_DO2 represented in FIG. 10, which module is driven by the microprocessor μP of the processing unit UT_DO2. The entropy decoding module MDE1_DO2 is for example of CABAC type. It may also be a Huffman decoder known as such.

In the course of a step D′311 represented in FIG. 9, there is undertaken the dequantization of the block BDq1ᵤ. Such a step being identical to the aforementioned step D4, it will not be described at greater length. decoded dequantized block BDt1ᵤ is then obtained.

In the course of a step D′312 represented in FIG. 9, there is undertaken the inverse transformation of the decoded dequantized block BDt1ᵤ. Such a step being identical to the aforementioned step D5, it will not be described at greater length. A decoded residual block BDr1ᵤ is then obtained.

In the course of a step D′4 represented in FIG. 9, there is undertaken, in a manner known per se, the reconstruction of the current block Bᵤ by conventional techniques of intra and/or inter prediction with the aid of a predictor block BP1ₛₑₗ. Such a step consists in adding to the decoded current residual block BDr1ᵤ the predictor block BP1ₛₑₗ, selected conventionally.

A decoded block BDᵤ is then obtained subsequent to step D′4 and stored in the buffer memory MT_DO2 of FIG. 10, so as to be used by the decoder DO2 as candidate predictor block of a following block to be decoded.

Steps D′311 to D′4 are implemented by an inverse predictive decoding software module PRED1⁻¹_DO2 represented in FIG. 10, which module is driven by the microprocessor _{I}P of the processing unit UT_DO2.

In the course of a step D′5 represented in FIG. 9, said decoded block BDᵤ is written in a decoded image IDⱼ. Such a step is implemented by an image reconstruction software module URI2 such as represented in FIG. 10, said module being driven by the microprocessor μP of the processing module UT_DO2.

In the course of a following step D′6 represented in FIG. 9, the decoder DO2 tests whether the current block BDᵤ which has just been decoded is the last block contained in the stream φ1.

If such is the case, in the course of a step D′7 represented in FIG. 9, the decoding method is terminated.

If such is not the case, there is undertaken, in the course of step D′2, the selection of the following residual block Bq1ᵤ to be decoded in accordance with the aforementioned sequential order. The decoding method described hereinabove is then iterated for the set of S blocks to be decoded.

Case Where Id=1

In the course of a step D′320 represented in FIG. 9, there is undertaken the entropy decoding of the block Bq2ₒₚₜᵤ. Such a step being identical to the aforementioned step D3, it will not be described at greater length. A decoded quantized block BDq2ₒₚₜᵤ is then obtained on completion of this step.

Such an entropy decoding step is implemented by an entropy decoding software module MDE2_DO2 represented in FIG. 10.

In the course of a step D′321 represented in FIG. 9, there is undertaken the dequantization of the block BDq2ₒₚₜᵤ. Such a step being identical to the aforementioned step D4, it will not be described at greater length. A decoded dequantized block BDt2ₒₚₜᵤ is then obtained.

In the course of a step D′322 represented in FIG. 9, there is undertaken the inverse transformation of the decoded dequantized block BDt2ₒₚₜᵤ. Such a step being identical to the aforementioned step D5, it will not be described at greater length. A decoded residual block BDr2ₒₚₜᵤ is then obtained. Said decoded residual block BDr2ₒₚₜᵤ is then stored in the buffer memory MT_DO2 of FIG. 10, so as to be used by the decoder DO2 as candidate predictor block of a following block to be decoded.

Steps D′321 and D′322 are implemented by an inverse predictive decoding software module PRED2⁻¹_DO2 represented in FIG. 10, which module is driven by the microprocessor μP of the processing unit UT_DO2.

In the course of a step D′323 represented in FIG. 9, there is undertaken according to the invention the determination of a set of Q candidate predictor blocks BP2₁, BP2₂, . . . , BP2ᵥ, . . . , BP2_{Q} (1≦v≦Q). Such a step being identical to step D6 of FIG. 8, it will not be described at greater length.

Such a determination step is implemented by a determination software module DET_DO2 represented in FIG. 10, which module is driven by the microprocessor μP of the processing unit UT_DO2.

In the course of a step D′324 represented in FIG. 9, there is undertaken according to the invention the identification, from among the set of Q predictor blocks BP2₁, BP2₂, . . . , BP2ᵥ, . . . , BP2_{Q}, of a preferential candidate predictor block BP2ₒₚₜ. According to the invention, in the same manner as during the aforementioned coding, such an identification step is dependent on the decoded residual block BDr2_{optz} obtained.

Said identification step is implemented by a calculation software module CALI_DO2 represented in FIG. 10, which module is driven by the microprocessor μP of the processing unit UT_DO2.

In the same manner as a step D6 of FIG. 8, the decoding method according to this other embodiment uses a minimization criterion for the difference between the decoded pixels of the current image ICⱼ, which are represented by points in FIG. 4, and the pixels of the decoded block BDr1_{u,w} situated along its boundary F. This criterion is a mathematical operator denoted SM(BDr1_{u,w}, ICⱼ).

It may be written in the following manner:

$$SM ( BDr {1}_{z , w} , {IC}_{j} ) = {\sum }_{a = 0}^{N - 1} {( BDr {1}_{z , w} ( 0 , a ) - {IC}_{j} ( row - 1 , col + a ) )}^{2} + {\sum }_{a = 0}^{N - 1} {( BDr {1}_{z , w} ( a , 0 ) - {IC}_{j} ( row + a , col - 1 ) )}^{2}$$

where:
BDr1ᵤ is the decoded block considered of size N×N pixels,
BDr1_{u,w}(n,m) is the value of the pixel of the decoded block BDr1_{u,w} situated in the nth row and the mth column of this block,
ICⱼ is the current image,
ICᵢ(k,l) is the value of the pixel of the image ICⱼ situated in the kth row and the Ith column of this image, and (row,col) are the coordinates of the decoded residual block BDr1_{u,w} in the image ICⱼ.

By way of alternative, it is possible to use a simplified criterion where one compares the average of the pixels of the image ICⱼ along the boundary F and the average of the pixels of the decoded block BDr1_{u,w}. The operator SM(BDr1_{u,w}, ICⱼ may then be written:

$$SM ( BDr {1}_{u , w} , {IC}_{j} ) = abs ( \frac{1}{( 2 N - 1 )} {\sum }_{a = 0}^{N - 1} ( {IC}_{j} ( row - 1 , col + a ) + {IC}_{j} ( row + a , col - 1 ) ) - \frac{1}{{N}^{2}} {\sum }_{a = 0}^{N - 1} {\sum }_{b = 0}^{N - 1} ( BDr {1}_{u , w} ( a , b ) ) )$$

where abs( ) represents the absolute value.

In the course of step D′324, there is undertaken the identification of the decoded block BDr1_{v,wmin} which minimizes one of the two aforementioned chosen criteria, such that:

wmin=argmin_{w}SM(BDr1_{u,w}, ICⱼ)

The block BDr1_{v,wmin} is equal to the sum of the candidate predictor block BP2_{wmin} and of the current decoded residual block BDr2ₒₚₜᵤ.

On completion of step D′324, the candidate predictor block BP2_{wmin} is considered to be the candidate preferential predictor block BP2ₒₚₜ with a view to the inverse prediction of the current decoded residual block BDr2ₒₚₜᵤ.

In the course of a step D′325 represented in FIG. 9, there is undertaken the reconstruction of the current residual block BDrᵤ by adding to the decoded current residual block BDr2ₒₚₜᵤ the preferential candidate predictor block BP2ₒₚₜ identified in step D′324. Said step D′325 is implemented by a calculation software module CAL2_DO2 represented in FIG. 10, which module is driven by the microprocessor μP of the processing unit UT_DO2.

Steps D′4 and D′5 aforementioned are thereafter repeated to deliver a current block BDᵤ. Next step D′6 is again implemented to test whether the current block BDᵤ is the last block of the image.

The steps of decoding the stream φᵢ (respectively φ₂) which have just been described hereinabove are implemented for all the blocks Bq1₁, Bq1₂, . . . , Bq1ᵤ, . . . , Bq_{S} (respectively Bq2ₒₚₜ₁, Bq2ₒₚₜ₂, . . . Bq2_{optS}) to be decoded of the current image ICⱼ considered.

It goes without saying that the embodiments which have been described hereinabove have been given purely by way of wholly non-limiting indication, and that numerous modifications can be easily made by the person skilled in the art without however departing from the scope of the invention.

1. A method for coding at least one image cut up into blocks, wherein the method comprises, for a current block to be coded, the following acts performed by a coding device:
determining a set of candidate predictor blocks,
for a first candidate predictor block considered of said set:
obtaining a residual block representative of a difference between the first candidate predictor block considered and the current block,
identifying, in said set of candidate predictor blocks, second candidate predictor block, said identification being dependent on said current residual block obtained and on said second candidate predictor block,
selecting said first candidate predictor block considered if it is equal to said second predictor block identified,
for each of the candidate predictor blocks of said set, other than said first candidate predictor block considered, implementing the acts of obtaining, identifying and selecting,
determining, from among the candidate predictor blocks that have been selected on completion of the selecting act, a candidate predictor block, with the aid of a predetermined criterion, and
coding the residual block representative of the difference between the candidate predictor block determined and the current block.

2. The coding method as claimed in claim 1, in which, said blocks of the image preceding the current block being coded in a determined order, said act of identifying is dependent on the previously coded pixels of the image.

3. The coding method as claimed in claim 2, in which said previously coded pixels of the image are situated along the current block.

4. The coding method as claimed in claim 1, in which said predetermined criterion is a minimization of an image bitrate-distortion cost.

5. The coding method as claimed claim 1, in which the current block is a block that has been previously obtained subsequent to a prediction.

6. A device for coding at least one image cut up into blocks, wherein the device comprises, for a current block to be coded:
means for determining a set of candidate predictor blocks, for a first candidate predictor block considered of said set:
means for obtaining a residual block representative of the difference between the first candidate predictor block considered and the current block,
means for identifying, in said set of candidate predictor blocks, a second candidate predictor block, as a function of said current residual block obtained and of said second candidate predictor block,
means for selecting said first candidate predictor block considered if it is equal to said second predictor block identified,
said obtaining, identifying and selecting means being activated for each of the candidate predictor blocks of said set, other than said first candidate predictor block considered,
means for determining, from among the candidate predictor blocks that have been selected by said selecting means, a candidate predictor block, with the aid of a predetermined criterion, and
means for coding the residual block representative of the difference between the candidate predictor block determined and the current block.

7. A non-transitory computer-readable medium comprising a computer program stored thereon and comprising program code instructions for execution of a coding method for coding at least one image cut up into blocks, when said program is executed on a computer of a coding device, wherein the instructions configure the coding device to perform acts of:
determining a set of candidate predictor blocks, for a first candidate predictor block considered of said set:
obtaining a residual block representative of a difference between the first candidate predictor block considered and the current block,
identifying, in said set of candidate predictor blocks, a second candidate predictor block, said identification being dependent on said current residual block obtained and on said second candidate predictor block,
selecting said first candidate predictor block considered if it is equal to said second predictor block identified,
for each of the candidate predictor blocks of said set, other than said first candidate predictor block considered, implementing the acts of obtaining, identifying and selecting,
determining, from among the candidate predictor blocks that have been selected on completion of the selecting act, a candidate predictor block, with the aid of a predetermined criterion, and
coding the residual block representative of the difference between the candidate predictor block determined and the current block.

8. A method for decoding a data signal representative of at least one image cut up into blocks, said method comprising of the following acts performed by a decoding device:
determination determining, in the data signal, data representative of a current residual block associated with a current block to be decoded,
decoding of said current residual block, and for a current block to be reconstructed, the acts of:
determining a set of candidate predictor blocks,
identifying, in said set, of a candidate predictor block, said identification being dependent on said decoded current residual block and on said candidate predictor block, and
reconstruction of reconstructing the current block with the aid of the identified predictor block and of the decoded current residual block.

9. The decoding method as claimed in claim 8, in which said blocks of the image preceding the current block being decoded in a determined order, said identification is dependent on the previously decoded pixels of the image.

10. The decoding method as claimed in claim 9, in which said previously decoded pixels of the image are situated along the current block.

11. The decoding method as claimed in claim 8, furthermore comprising determining, in the data signal, an item of information associated with a prior prediction of the current block, said act of reconstructing the current block being implemented on the basis of said prior prediction, of said identified predictor block and of the determined current residual block.

12. A device for decoding a data signal representative of at least one image cut up into blocks, said device comprising:
means for determining, in the data signal, data representative of a current residual block associated with a current block to be decoded,
means for decoding said current residual block,
for a current block to be reconstructed:
means for determining a set of candidate predictor blocks,
means for identifying, in said set, a candidate predictor block, said identifying being dependent on said decoded current residual block and on said candidate predictor block,
means for reconstructing the current block with the aid of the identified predictor block and of the decoded current residual block.

13. A non-transitory computer-readable medium comprising a computer program stored thereon and comprising program code instructions for execution of a decoding method for decoding a data signal representative of at least one image cut up into blocks, when said program is executed on a computer of a decoding device, wherein the instructions configure the decoding device to perform acts of:
determining, in the data signal, data representative of a current residual block associated with a current block to be decoded,
decoding said current residual block, and
for a current block to be reconstructed, the acts of:
determining a set of candidate predictor blocks,
identifying, in said set, of a candidate predictor block, said identification being dependent on said decoded current residual block and on said candidate predictor block, and
reconstructing the current block with the aid of the identified predictor block and of the decoded current residual block.
